(19) United States
(12) Patent Application Publication
(10) Pub. No.: US 2006/0154092 A1
(43) Pub. Date: Jul. 13, 2006

(54) Front plante for plasma dispay and plasma display

(75) Inventors: Nobuo Naito, Tokyo-To (JP); Fumihiro Arakawa, Tokyo-To (JP); Tadahiro Masaki, Tokyo-To (JP)

Correspondence Address: OLIFF & BERRIDGE, PLC, P.O. BOX 19928, ALEXANDRIA, VA, 22320, US

(73) Assignee: DAI NIPPON PRINTING CO., LTD, Tokyo-To (JP)

(21) Appl. No.: 10/562,424

(22) PCT Filed: Jul. 27, 2004
(86) PCT No.: PCT/JP04/10663

§ 371 Date: Dec. 27, 2005

(51) Int. Cl. B32B 15/04

(52) U.S. Cl. 428/457

(57) ABSTRACT

A front panel for plasma display comprises a transparent substrate 11 and an electromagnetic wave shielding layer 30 provided on one surface of the transparent substrate 11 through a first transparent adhesive layer 21. The electromagnetic wave shielding layer 30 comprises a transparent substrate film 31, a metal layer 35 that includes a mesh part 203 and a frame part 201 surrounding the mesh part 203, and a smoothing resin layer 39. On the metal layer 35 is provided a blackening treatment layer 37. A third transparent adhesive layer 41 and a transparent protective layer 50 are laminated in this order to the electromagnetic wave shielding layer 30. The smoothing resin layer 39 and/or the third transparent adhesive layer 41 contains a near infrared rays absorbing agent and a coloring agent for color tone correction.

### FIELD OF THE INVENTION

The present invention relates to a front panel for a plasma display, and more particularly, to a front panel for a plasma display that is mounted on the front of a plasma display element (also referred to as a PDP) so as to shield electromagnetic waves and near infrared rays that are emitted from the element and also to make an image displayed on a display (also referred to as an image display) highly visible.

### BACKGROUND ART

1. Background of the Invention

A PDP is composed of a glass substrate having a data electrode and a fluorescent layer, and a glass substrate having a transparent electrode, with a gas such as xenon or neon being sealed in a space between the two glass substrates. PDPs can be made large in screen size as compared with conventional CRT-TVs and have come to be used widely. In operation, a PDP produces, as unwanted radiation, large amounts of electromagnetic waves, near infrared rays, and unwanted light with specific wavelengths. In order to shield or reduce these electromagnetic waves, near infrared rays, and unwanted light with specific wavelengths, a front panel for a plasma display (composite filter) is mounted on the front of the PDP. A PDP and a front panel for a plasma display constitute a plasma display. Such a front panel for a plasma display is required to have the properties of shielding electromagnetic waves, near infrared rays, and unwanted light with specific wavelengths originating from the emission spectrum of an insert gas. The required shielding efficiency for electromagnetic waves with frequencies of 30 MHz to 1 GHz, emitted from a display element, is 30 dB or more. Further, since near infrared rays with wavelengths of 800 to 1,100 nm, emitted from a PDP, cause malfunctioning of other equipment such as VTRs, it is necessary to shield these rays by a front panel for plasma display. Furthermore, it is also necessary to correct the inherent emission spectrum of an insert gas characteristic of a PDP or to adjust the color tone of this spectrum to a preferred one by the use of a front panel for plasma display, thereby optimizing the color quality to improve image quality. Moreover, a front panel for plasma display is required to have, in addition to moderate transparency (visible light transmittance) and luminance, various functions such as the function of imparting the property of preventing reflection of extraneous light and the anti-glare properties to a display so that an image displayed on the display can be seen with high visibility, and high mechanical strength. To obtain these functions (a variety of filters), there has been proposed a construction in which functional layers such as an electromagnetic wave (EMI) shielding layer, a near infrared rays (NIR) shielding layer, and an anti-reflection layer are provided on both surfaces of a transparent substrate of a front panel for a plasma display, as disclosed in Japanese Laid-Open Patent Publication No. 15533/2003 (especially in FIGS. 2 and 3 and Examples 2 and 9). These shielding layers are formed while reversing the transparent substrate such as a glass plate, which is large in area, heavy, and fragile, so that the formation of the shielding layers is not easy and requires a number of steps. In addition, the functional layers that have to be laminated are of a number of types, and it is necessary to successively laminate these layers with an adhesive. Therefore, the conventional front panel has been expensive. For this reason, there is demand for a front panel for a plasma display that can be produced accurately and stably at low cost in a small number of steps and that can be mounted on a plasma display with ease.

To meet the above demands, a front panel composed of an electromagnetic wave shielding layer, a near infrared rays shielding layer, an anti-reflection layer, and so on that are successively laminated only to one surface of a transparent substrate has been proposed as disclosed in Japanese Laid-Open Patent Publications No. 6685412003 and No. 324431/2002. Although this front panel can solve the problem that a transparent substrate has to be reversed, the problem that a number of steps are needed to laminate various types of functional layers (to laminate five functional layers, five lamination steps are needed) still remains unsolved. The process for producing this front panel is thus complicated and costly.

2. Related Art

A conventional electromagnetic wave shielding assembly (equivalent to a front panel for a plasma display of the present invention) comprises an electromagnetic wave shielding adhesive film or a member using such a film that shows excellent electromagnetic wave and infrared rays shielding properties, high transparency, and invisibility when properly connected to an external electrode for grounding. For example, Japanese Laid-Open Patent Publication No. 15533/2003 describes a terminal area for grounding that is formed by removing the upper layers of the electromagnetic wave shielding assembly by a laser; Japanese Laid-Open Patent Publication No. 66854/2003 describes the formation of an edge part (terminal area) by removing only one upper layer of the electromagnetic wave shielding assembly; and Japanese Laid-Open Patent Publication No. 324431/2002 describes the formation of an electrode (terminal area) from a silver paste or a conductive tape. These techniques are disadvantageous in that they demand additional steps for the formation of the terminal areas, and also facilities and materials for use in the additional steps, which leads to an increase in costs.

Further, there have also been known front filter glasses for a plasma display (equivalent to a front panel for a plasma display of the present invention) that scarcely leak electromagnetic waves or near infrared rays, that are excellent in color, brightness, and anti-reflection properties, and that are inexpensive.

For example, a front filter glass described in Japanese Laid-Open Patent Publication No. 235115/2000 comprises a laminate of a conductive inorganic film (electromagnetic wave shield)/a resin film/a hard coat layer/an anti-reflection layer, provided on one surface of a substrate. In this front filter glass, a near infrared rays absorbing agent and/or a color compensation dye is incorporated in the resin film and/or the hard coat layer, so that the separate step of incorporating the near infrared rays absorbing agent in the resin film is further needed. It is, therefore, necessary to conduct small lot production for each type of the front filter glass.

As described above, there have so far been no front panels for plasma display that meet, all at once to the practical level, the requirements such as excellent electromagnetic wave shielding properties, good image quality, high image visibility, high mechanical strength, easiness of production, and low cost.

### DISCLOSURE OF THE INVENTION

The present invention was accomplished in order to solve the aforementioned problems in the prior art. An object of the present invention is therefore to provide a front panel for a plasma display having the properties of shielding electromagnetic waves, near infrared rays, and unwanted light with specific wavelengths originating from the emission spectrum of an insert gas, capable of optimizing color quality to bring about a preferred color tone, having moderate transparency (visible light transmittance) and luminance, as well as the function of imparting, to a display, the property of preventing reflection of extraneous light and the anti-glare properties that raise image visibility, capable of being produced accurately and stably at low cost in a small number of steps without waste of materials, and capable of being easily mounted on a PDP; and a plasma display provided with the front panel.

The present invention is a front panel for plasma display, comprising a transparent substrate, a first transparent adhesive layer provided on the transparent substrate, an electromagnetic wave shielding layer provided on the first transparent adhesive layer, a third transparent adhesive layer provided on the electromagnetic wave shielding layer, and a transparent protective layer provided on the third transparent adhesive layer, the electromagnetic wave shielding layer comprising a transparent substrate film, a metal layer including a mesh part having a plurality of openings that adjoin one another, formed on the transparent substrate film, and a smoothing resin layer made from a transparent synthetic resin, filling at least part of the spaces in the openings in the metal layer, the smoothing resin layer and/or the third transparent adhesive layer containing a near infrared rays absorbing agent and/or a coloring agent for color tone correction.

The present invention is the above-described front panel for plasma display, wherein the smoothing resin layer and/or the third transparent adhesive layer contains both a near infrared rays absorbing agent and a coloring agent for color tone correction.

The present invention is the above-described front panel for plasma display, wherein the smoothing resin layer and/or the third transparent adhesive layer further contains a coloring agent for color tone adjustment for adjusting the color tone of a displayed image to the desired one.

The present invention is the above-described front panel for plasma display, wherein the smoothing resin layer contains a near infrared rays absorbing agent, and the third transparent adhesive layer contains a coloring agent for color tone correction.

The present invention is the above-described front panel for plasma display, wherein the third transparent adhesive layer further contains a coloring agent for color tone adjustment.

The present invention is the above-described front panel for plasma display, wherein the metal layer further includes a frame part that surrounds the mesh part, and a part of the frame part is covered neither with the smoothing resin layer, nor with the third transparent adhesive layer, nor with the transparent protective layer and is thus bare.

The present invention is the above-described front panel for plasma display, wherein the electromagnetic wave shielding layer comprises a second transparent adhesive layer between the transparent substrate film and the metal layer.

The present invention is the above-described front panel for plasma display, wherein the transparent protective layer comprises a transparent protective substrate film and an anti-reflection layer and/or an anti-glaring layer provided on the transparent protective substrate film.

The present invention is the above-described front panel for plasma display, wherein a blackening treatment layer is provided on the transparent protective layer side surface of the metal layer.

The present invention is a plasma display comprising a front panel for plasma display and a plasma display element that faces to the front panel for plasma display, the front panel for plasma display comprising a transparent substrate, a first transparent adhesive layer provided on the transparent substrate, an electromagnetic wave shielding layer provided on the first transparent adhesive layer, a third transparent adhesive layer provided on the electromagnetic wave shielding layer, and a transparent protective layer provided on the third transparent adhesive layer, the electromagnetic wave shielding layer comprising a transparent substrate film, a metal layer including a mesh part having a plurality of openings that adjoin one another, formed on the transparent substrate film, and a smoothing resin layer made from a transparent synthetic resin, filling at least part of the spaces in the openings in the metal layer, the smoothing resin layer and/or the third transparent adhesive layer containing a near infrared rays absorbing agent and/or a coloring agent for color tone correction, the transparent substrate of the front panel for plasma display facing to the plasma display element, an image displayed being observed from the transparent protective layer side.

The present invention is the above-described plasma display, wherein the smoothing resin layer and/or the third transparent adhesive layer contains both a near infrared rays absorbing agent and a coloring agent for color tone correction.

The present invention is the above-described plasma display, wherein the smoothing resin layer and/or the third transparent adhesive layer further contains a coloring agent for color tone adjustment for adjusting the color tone of a displayed image to the desired one.

The present invention is the above-described plasma display, wherein the smoothing resin layer contains a near infrared rays absorbing agent, and the third transparent adhesive layer contains a coloring agent for color tone correction.

The present invention is the above-described plasma display, wherein the third transparent adhesive layer further contains a coloring agent for color tone adjustment.

The present invention is the above-described plasma display, wherein the metal layer further includes a frame part that surrounds the mesh part, and a part of the frame part is covered neither with the smoothing resin layer, nor with the third transparent adhesive layer, nor with the transparent protective layer and is thus bare.

The present invention is the above-described plasma display, wherein the electromagnetic wave shielding layer comprises a second transparent adhesive layer between the transparent substrate film and the metal layer.

The present invention is the above-described plasma display, wherein the transparent protective layer comprises a transparent protective substrate film and an anti-reflection layer and/or an anti-glaring layer provided on the transparent protective substrate film.

The present invention is the above-described plasma display, wherein a blackening treatment layer is provided on the transparent protective layer side surface of the metal layer.

(Gist of the Invention)

According to the present invention, functional layers such as an electromagnetic wave (EMI) shielding layer, a near infrared rays (NIR) shielding layer, a color tone correction layer and/or a color tone adjustment layer, and a protective layer (also including an anti-reflection (AR) layer and/or an anti-glare (AG) layer) are laminated to one surface of a transparent substrate. To produce a front panel of the present invention, it is not necessary to laminate the functional layers to both surfaces of a transparent substrate, unlike in the production of conventional front panels, so that there is no need to reverse the transparent substrate that is large in area, fragile, and poor in handling properties. Therefore, by the use of simple production facilities, the front panel can be produced with few cracks, resulting in improved yield and throughput. Further, although a conventional front panel has, for example, been produced by laminating at least five previously-prepared functional layers, an EMI shielding layer, an NIR shielding layer, a color tone correction layer, a color tone adjustment layer, and an AR layer, to both surfaces of a transparent substrate in 5 steps, a front panel of the present invention can be obtained by laminating two layers, such as a combination of an EMI shielding film having the function of shielding NIR and the function of correcting color tone and an AR film, in 2 steps with an adhesive layer having the function of adjusting color tone. The present invention can thus decrease the number of necessary steps, improve yield and throughput, and reduce costs. Furthermore, the mesh part of the metal layer is covered with the smoothing resin layer, and the concavities in the mesh part, especially the corners thereof, are filled with the smoothing resin layer. Therefore, when the transparent protective layer is attached to the mesh part with the third transparent adhesive layer, air bubbles are not produced. A conventional front panel comprises no smoothing resin layer, and a transparent protective layer is attached directly to a mesh part with a transparent adhesive layer, so that the pressuring step is needed for removing air bubbles produced in the concavities of the mesh part at the corners thereof.

According to the present invention, by incorporating a coloring agent for color tone adjustment in addition to the near infrared rays absorbing agent and the coloring agent for color tone correction, it is possible to adjust the color tone of a displayed image according to the customer's preference.

According to the present invention, it is possible to incorporate the near infrared rays absorbing agent and the coloring agent for color tone correction separately in the smoothing resin layer and the third transparent adhesive layer, respectively, so that it is easy to control only the coloring agent for color tone correction that requires the adjustment of transmittance.

According to the present invention, in the case where the coloring agent for color tone adjustment is incorporated in the third transparent adhesive layer, the step of incorporating this coloring agent is effected at a point close to the end of the whole production process, so that it is possible to produce semi-finished products in a lump according to the common specifications in the steps prior to the step of incorporation. Therefore, the front panel can be produced at low cost, and the color tone of a displayed image can be easily adjusted according to customer's preference.

Further, according to the present invention, it is possible to ground the front panel by its frame part without forming a terminal area. Furthermore, since the smoothing resin layer is applied pattern-wise, as needed, it is possible to reduce the material costs.

According to the present invention, the transparent substrate film and the metal layer adhere to each other more firmly. When a near infrared rays absorbing agent is incorporated in the smoothing resin layer, and a coloring agent for color tone correction, in the third transparent adhesive layer, there is provided a front panel for plasma display in which the coloring agent for color tone correction that requires adjustment of transmittance can be controlled with ease.

According to the present invention, there is provided a front panel for plasma display having the anti-reflection function and/or the anti-glaring function.

According to the present invention, when a blackening treatment layer is provided on the transparent protective layer side surface of the metal layer, a displayed image can be seen with high contrast even in the presence of extraneous light.

According to the present invention, there is provided a plasma display that is shielded so as not to emit electromagnetic waves, near infrared rays, and light with specific wavelengths originating from the emission spectrum of an insert gas, that can display an image with a color tone adjusted according to customer's preference, and that can display a highly visible image owing to the property of preventing reflection of extraneous light and the anti-glare properties imparted.

### BRIEF DESCRIPTION OF THE DRAWINGS

FIG. 1A is a cross-sectional view of a plasma display according to the present invention, which is an enlarged view of part A in FIG. 1B;

FIG. 1B is a diagrammatic view of the plasma display;

FIG. 1C is a view showing a transparent protective layer;

FIG. 2 is a plan view of an electromagnetic wave shielding layer; and

FIGS. 3A and 3B are cross-sectional views of mesh parts of the electromagnetic wave shielding layer.

### BEST MODE FOR CARRYING OUT THE INVENTION

Embodiments of the present invention will be described in detail with reference to the accompanying drawings.

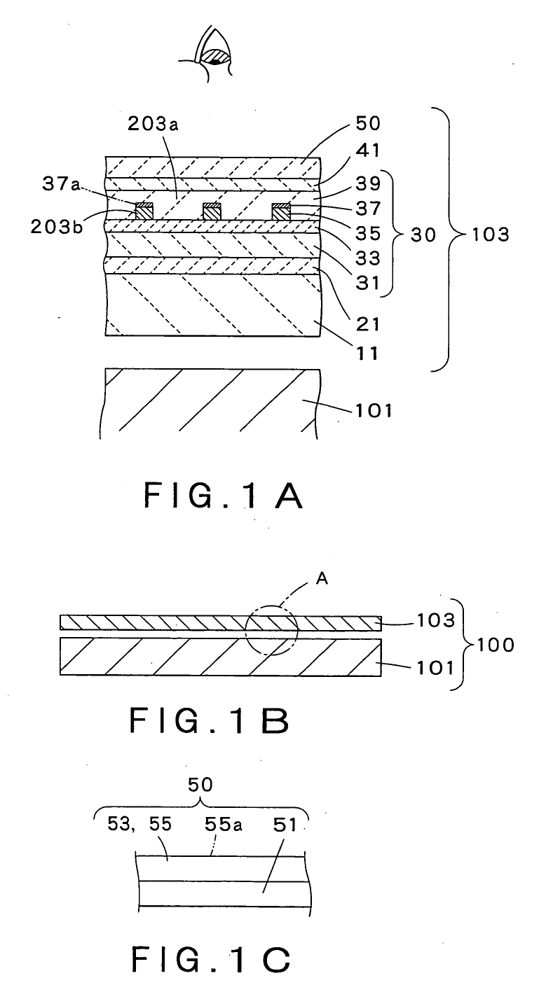

As shown in FIGS. 1A to 1C, a plasma display 100 comprises a plasma display element (PDP) 101, and a front panel 103 for plasma display provided on the observation side of the plasma display element (PDP) 101.

The front panel 103 for plasma display comprises a transparent substrate 11. Further, a first transparent adhesive layer 21/an electromagnetic wave shielding layer 30/a third transparent adhesive layer 41/a transparent protective layer 50 are laminated to one surface of the transparent substrate 11.

The front panel 103 for plasma display of the above construction has all the functions required for a front panel for plasma display.

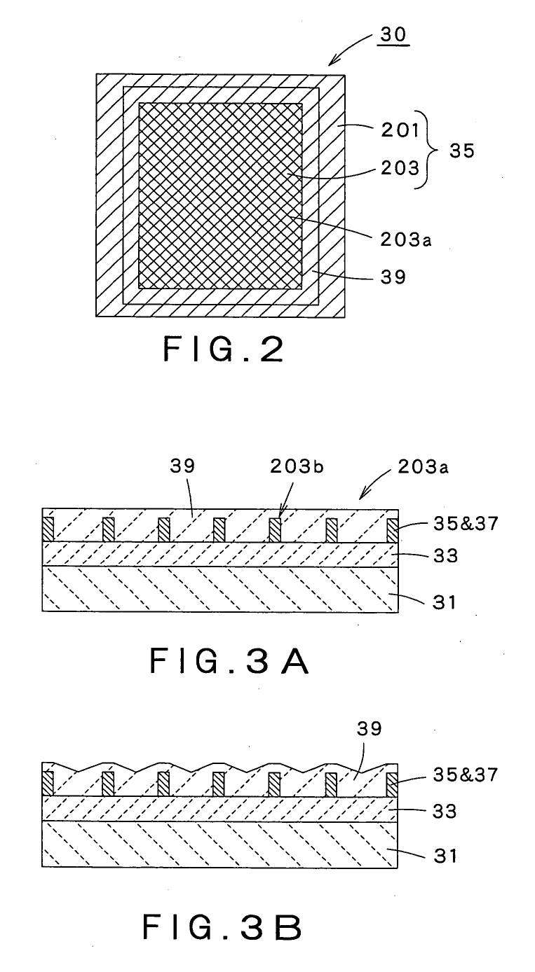

The electromagnetic wave shielding layer 30 comprises a transparent substrate film 31, an optional second transparent adhesive layer 33, a metal layer 35, and a smoothing resin layer 39. As shown in FIG. 2, the metal layer 35 includes at least a mesh part 203.

This mesh part 203 has a plurality of openings 203a that adjoin one another. For the purpose of grounding, the metal layer 35 may further include a frame part 201 that surrounds the mesh part 203.

A blackening treatment layer 37 is optionally provided on the transparent protective layer side surface of the metal layer 35. The transparent protective layer 50 comprises a transparent substrate film 51 and an anti-reflection layer 53 and/or an anti-glaring layer 55 provided on the transparent substrate film 51 (FIG. 1C).

It was found that by incorporating, in the specified layers, the below-defined multiple coloring agents, “a near infrared rays absorbing agent”, “a coloring agent for color tone correction”, and “a coloring agent for color tone adjustment”, having different functions and physical properties, it is possible to obtain specific effects and to decrease the number of constituent layers. The present invention was accomplished on the basis of this finding.

(Definitions of Coloring Agents)

Since a plurality of coloring agents is used in the present invention, they are, in this Specification, defined as follows in order to avoid confusion. A coloring agent that shields near infrared rays with wavelengths of 800 to 1,100 nm, emitted from a PDP, is called “a near infrared rays absorbing agent (also referred to as an NIR absorbing agent)”. A coloring agent that corrects the color tone of the inherent emission spectrum of an insert gas (such as neon) characteristic of a PDP, that is, unwanted light with specific wavelengths, is called “a coloring agent for color tone correction (also referred to as a Ne light absorbing agent when the coloring agent is for absorbing the neon atom spectrum)”. A coloring agent for adjusting the color tone of an image to a favorite one is called “a coloring agent for color tone adjustment”.

(Production of and Materials for Front Panel for Plasma Display)

Layer construction of a front panel for plasma display of the present invention and a process for producing the front panel are typically as follows:
(1) First, a transparent substrate 11, a first transparent adhesive layer 21, and a third transparent adhesive layer 41 are prepared.
(2) Separately, an electromagnetic wave shielding layer 30 that has been subjected to pre-processing is prepared.
(3) Separately, a transparent protective layer 50 that has been subjected to pre-processing is prepared.
(4) The electromagnetic wave shielding layer 30 is laminated to the transparent substrate 11 with the first transparent adhesive layer 21.
(5) Subsequently, the transparent protective layer 50 is laminated to the electromagnetic wave shielding layer 30 with the third transparent adhesive layer 41.

The production process and materials to be used will be described hereinafter.

(Transparent Substrate)

The essential requirement for materials for the transparent substrate 11 is mechanical strength. Examples of materials useful herein include glass, polycarbonate resins, polyester resins, cellulose resins such as triacetyl cellulose and diacetyl cellulose, styrene resins, and acrylic resins such as poly(meth)acrylate and polymethyl (meth)acrylate. Of these, glass and acrylic resins consisting of polymethyl methacrylic polymers are preferred.

(Meth)acrylate herein means acrylate or methacrylate.

From the viewpoint of image visibility, it is preferable that the transparent substrate 11 be transparent to visible light and has a mean transmittance of not less than 50% for visible light with wavelengths of 450 to 650 nm. Further, coloring agents, ultraviolet light absorbers, antioxidants, antistatic agents, fire retardants, and the like may be incorporated, as needed, in the transparent substrate unless they affect the functions of the substrate. Although the transparent substrate may have any thickness, the thickness is usually about 1 to 10 mm, preferably 2 to 6 mm. A transparent substrate with a thickness of less than the above range is insufficient in mechanical strength, while a transparent substrate with a thickness of more than the above-described range has excessively high mechanical strength and is not practical because such a substrate is heavy.

(First and Third Transparent Adhesive Layers)

The first transparent adhesive layer 21 and the third transparent adhesive layer 41 may be made from similar materials, and conventional adhesives or so-called pressure-sensitive adhesives can be used for these layers.

(Adhesives)

For the adhesives can be used those ones that cure in ionizing radiation such as ultraviolet rays (UV) or electron beams (EB), or in heat. Specific examples of thermosetting adhesives useful herein include two-part curing urethane adhesives (e.g., polyester urethane adhesives, polyether urethane adhesives, etc.), acrylic adhesives, polyester adhesives, polyamide adhesives, polyvinyl acetate adhesives, epoxy adhesives, and rubber adhesives. Of these, two-part curing urethane adhesives are preferred.

Examples of ionizing radiation curing resins useful herein include (meth)acrylate prepolymers such as urethane (meth)acrylate and polyester (meth)acrylate; (meth)acrylate monomers such as trimethylol propane (meth)acrylate and dipentaerythritol hexa(meth)acrylate; and epoxy resins ((meth)acrylate herein means acrylate or methacrylate).

(Pressure-Sensitive Adhesives)

For the pressure-sensitive adhesives can be used any of conventional ones. Examples of pressure-sensitive adhesives useful herein include natural rubber; synthetic rubber resins such as butyl rubber, polyisoprene, polyisobutylene, polychloroprene, and styrene-butadiene copolymer resins; vinyl acetate resins such as polyvinyl acetate and ethylene-vinyl acetate copolymers; alkylphenol resins; and rosin resins such as rosin, rosin triglyceride, and hydrogenated rosin; acrylic resins; and urethane resins.

(Pre-Processing of Electromagnetic Wave Shielding Layer)

FIG. 2 is a plan view of the electromagnetic wave shielding layer for use in the present invention, and FIG. 3 is a cross-sectional view of this layer. The electromagnetic wave shielding layer 30 is composed of a transparent substrate film 31/an optional second transparent adhesive layer 33/a metal layer 35/a smoothing resin layer 39. The metal layer 35, which is provided on the transparent substrate film 31, includes a mesh part 203 that is a meshwork area, and a frame part 201 surrounding the mesh part 203, optionally provided for the purpose of grounding the electromagnetic wave shielding layer 30. The mesh part 203 has openings 203a and line parts 203b constituting the metal layer 35, the openings 203a being surrounded by the line parts 203b. The mesh part 203 is formed by a conventional photolithographic process (1) or plating process (2).

(Photolithographic Process)

The photolithographic process (1) will be firstly explained. A metal layer 35 wholly made from a metal, having no meshes, is laminated to one surface of the transparent substrate film 31 through the second transparent adhesive layer 33 by dry lamination. Thereafter, a mesh part 203 is photolithographically formed in the metal layer 35. Preferably, at least the transparent protective layer 50 side surface of the metal layer 35 is subjected to blackening treatment, thereby forming on this surface a blackening treatment layer 37. This blackening treatment layer 37 may be formed either before or after laminating the metal layer 35 to the transparent substrate film 31. Further, after forming the mesh part, the blackening treatment layer 37 may be provided on the surface of the metal layer 35 that faces to the transparent protective layer 50. In this case, the blackening treatment layer 37 also covers the side faces of the line parts 203b, so that higher image contrast can be obtained even in the presence of extraneous light.

(Formation of Metal Layer by Plating)

The plating process (2) for forming a metal layer in the form of meshes will be described below. A metal layer 35 is formed directly on one surface of the transparent substrate film 31 by plating. The plating process is as follows: one surface of the transparent substrate film 31 is subjected to treatment for making this surface electrically conductive according to a pattern consisting of a mesh part existing at the center and a frame part surrounding the mesh part, and is then plated with a metal. Thus, the mesh part 203 and the frame part 201 surrounding the mesh part 203 are formed simultaneously, thereby obtaining the metal layer 35. In this case, the second transparent adhesive layer 33 is unnecessary. At least on the surface of the metal layer 35 on the transparent protective layer 50 side is then formed a blackening treatment layer 37. The blackening treatment layer 37 may be formed in a manner similar to the manner employed in the above-described photolithographic process, and an anticorrosive layer 37a may further be formed, if necessary, on the blackening treatment layer 37. Although materials for the transparent substrate film 31, the metal layer 35, and the blackening treatment layer 37 that are used in the plating process are the same as those ones that are used in the photolithographic process (1), the manner in which the metal layer is formed in the plating process is different from that in the photolithographic process. When conducting treatment for making the transparent substrate film electrically conductive in order to form the mesh part 203 as desired and the frame part 201 around the periphery of the mesh part 203, the desired mesh pattern is used.

(Substrate Film)

Any of various materials can be used for the transparent substrate film 31 as long as it has transparency, insulating properties, heat resistance, mechanical strength, and so on that can stand for service and production conditions. Examples of materials useful herein include polyester resins such as polyethylene terephthalate and polyethylene naphthalate; polyamide resins such as nylon 6 and nylon 610; polyolefin resins such as polypropylene and polymethyl pentene; vinyl resins such as polyvinyl chloride; acrylic resins such as poly(meth)acrylate and polymethyl (meth)acrylate; engineering resins such as polyallylate, polysulfone, polyphenylene ether and polyaramide; polycarbonate; styrene resins such as polystyrene; and cellulose resins such as triacetyl cellulose (TAC).

The transparent substrate film 31 may also be made from a copolymer resin or mixture (including an alloy) whose main components are resins selected from the above-enumerated ones, or may be a laminate of a plurality of layers. Although the transparent substrate film may be either an oriented or non-oriented film, it is preferable to use a monoaxially or biaxially oriented film to obtain improved strength. The thickness of the transparent substrate film 31 is usually about 12 to 1000 μm, preferably 50 to 700 μm, and most preferably 100 to 500 μm. A transparent substrate film 31 with a thickness of less than the above range cannot have sufficiently high mechanical strength and unfavorably curls and slacks, while a transparent substrate film 31 with a thickness of more than the above range has excessively high strength, which is wasteful from the viewpoint of cost. The transparent substrate film 31 may be a film, sheet, or board composed of at least one layer of any of the above-enumerated resins, and these forms are herein collectively referred to as films. In general, films of polyesters such as polyethylene terephthalate and polyethylene naphthalate are conveniently used for the transparent substrate film 31 because they are excellent in both transparency and heat resistance and are inexpensive, and, of these, polyethylene terephthalate is most preferred. With respect to the transparency of the transparent substrate film 31, the higher the better, and it is preferable that the transparent substrate film 31 has a visible light transmittance of not less than 80%.

The surface of the transparent substrate film 31 to be coated with an adhesive may be subjected to adhesion-improving treatment such as corona discharge treatment, plasma treatment, ozone treatment, flame treatment, primer (also referred to as anchoring agent, adhesion-promoting agent, or adhesion-improving agent) coating treatment, preheating, dusting, vacuum deposition, or alkali treatment. Additives such as ultraviolet light absorbers, plasticizers, and antistatic agents may also be incorporated in this transparent substrate film 31, as needed.

(Metal Layer)

Metals such as gold, silver, copper, iron, nickel, chromium, and aluminum, having electrical conductivity good enough to fully shield electromagnetic waves, can be used as materials for the metal layer 35. The metal layer may be a single layer of one metal or of an alloy, or composed of multiple layers. Examples of iron materials useful herein include low-carbon steels such as low-carbon rimmed steels and low-carbon aluminum killed steels, Ni—Fe alloys, and invar alloys. If cathodic electrodeposition is conducted as the blackening treatment, it is preferable to use copper or copper alloy foil as the metal layer because it is easy to conduct electrodeposition on such a material. Rolled or electrolytic copper foil may be used as the copper foil, and electrolytic copper foil is preferred because it is uniform in thickness, is highly adhesive to the blackening treatment layer and/or the chromate treatment layer, and can have a thickness as small as below 10 μm. The thickness of the metal layer 35 is approximately from 1 to 100 μm, and preferably from 5 to 20 μm. When the metal layer 35 has a thickness of less than the above range, although it is easy to photolithographically make meshes in the metal layer 35, the metal layer 35 has an increased electrical resistance value and shows impaired electromagnetic wave shielding effect. When the metal layer 35 has a thickness of more than the above range, it is impossible to obtain the desired minute meshes, so that the substantial opening rate becomes low. As a result, the light transmittance becomes lower and the viewing angle becomes narrower; image visibility thus becomes lower.

The surface roughness of the metal layer 35, as indicated by Rz value, is preferably from 0.5 to 10 μm. When the metal layer 35 has a surface roughness value lower than this range, it reflects extraneous light by mirror reflection even if it has been subjected to the blackening treatment, and image visibility (contrast) in the presence of extraneous light thus becomes lower. When the surface roughness value of the metal layer is in excess of the above range, an adhesive or resist does not spread, upon its application, over the entire surface of the metal layer or involves air to form air bubbles. The surface roughness Rz is a ten-point mean roughness value obtained in accordance with JIS-BO601 (1994).

(Second Transparent Adhesive Layer)

The metal layer 35 is laminated to the transparent substrate film 31 with the second transparent adhesive layer 33. Thermosetting adhesives, or ionizing radiation curing adhesives that cure in ionizing radiation such as ultraviolet rays or electron beams may be used for the second transparent adhesive layer 33. Specific examples of thermosetting adhesives herein useful include two-part curing urethane adhesives (e.g., polyester urethane adhesives, polyether urethane adhesives, etc.), acrylic adhesives, polyester adhesives, polyamide adhesives, polyvinyl acetate adhesives, epoxy adhesives, and rubber adhesives. Of these, two-part curing urethane adhesives are preferred.

(Pressure-Sensitive Adhesive)

Any of conventional pressure-sensitive adhesives can also be used for the second transparent adhesive layer 33. Examples of pressure-sensitive adhesives useful herein include natural rubber; synthetic rubber resins such as butyl rubber, polyisoprene, polyisobutylene, polychloroprene, and styrene-butadiene copolymer resins; vinyl acetate resins such as polyvinyl acetate and ethylene-vinyl acetate copolymers; rosin resins such as rosin, rosin triglyceride, and hydrogenated rosin; acrylic resins; and urethane resins.

(Lamination Process)

The process of laminating the transparent substrate film 31 and the metal layer 35 is as follows: one of the above-enumerated resins for the adhesive (or pressure-sensitive adhesive), or a mixture of two or more of the resins is made into a latex, an aqueous dispersion, or an organic solvent solution, which is then printed on or applied to the surface of either the transparent substrate film 31 or the metal layer 35 by a conventional printing or coating method such as screen printing, gravure printing, comma coating, or roll coating, and is dried, if necessary; the other member is superposed on this adhesive layer, and pressure is applied. The thickness of the adhesive layer is approximately from 0.1 to 20 μm (dry basis), preferably from 1 to 10 μm. Specifically, continuous belt-shaped (rolled-up) materials are usually used in the lamination process; the adhesive is applied to either the metal layer or the substrate film in the state of being unrolled from a wind-up roll and stretched, and is then dried; the other member is superposed on this adhesive layer, and pressure is applied. Further, aging (aging and hardening) is optionally conducted in an atmosphere at 30° to 80° C. for several hours to several days, thereby obtaining a laminate in the rolled-up state. This is a process that is called dry lamination by those skilled in the art. The use of ionizing radiation curing resins is also favorable.

(Dry Lamination)

Dry lamination is a process for laminating two materials in the following manner: by a coating method such as roll, reverse roll, or gravure coating, an adhesive dispersed or dissolved in a solvent is applied to one material so that the layer applied has a thickness of 0.1 to 20 μm (dry basis), preferably 1.0 to 5.0 μm, and the solvent is evaporated to form an adhesive layer; immediately after the formation of the adhesive layer, the other laminating material is laminated to the adhesive layer; and this laminate is aged at 30 to 120° C. for several hours to several days, thereby hardening the adhesive. The adhesive layer that is used in the dry lamination process is herein the second transparent adhesive layer 33, and thermosetting adhesives or ionizing radiation curing adhesives can be used for the second transparent adhesive layer 33. Specific examples of thermosetting adhesives include two-part curing urethane adhesives that are obtained by the reaction of polyfunctional isocyanates such as tolylene diisocyanate or hexamethylene diisocyanate with hydroxyl-group-containing compounds such as polyether polyols or polyacrylate polyols; acrylic adhesives; and rubber adhesives. Of these, two-part curing urethane adhesives are preferred.

(Photolithographic Process)

The metal surface of the laminate of the transparent substrate film 31/the second transparent adhesive layer 33/the metal layer 35 is photolithographically made into meshes. A resist layer is formed in a mesh pattern on this metal layer 35; those portions of the metal layer that are not covered with the resist layer are removed by etching; and then the resist layer is stripped, thereby making meshes in the metal layer. As shown in FIG. 2, the metal layer 35 in the electromagnetic wave shielding layer 30 includes the mesh part 203 and the frame part 201. The mesh part 203 has a plurality of openings 203a surrounded by line parts 203b, the remaining metal layer, and the frame part 201 has no openings and is wholly made of the metal layer. The frame part 201 is provided so that it surrounds the mesh part 203.

Photolithography is a process for processing a belt-shaped laminate in the state of a continuously wind-up roll. While transferring the laminate continuously or intermittently, masking, etching, and resist stripping are conducted with the laminate stretched and unslacked. First, masking is conducted in the following manner: a photosensitive resist, for example, is applied to the metal layer and is dried; this metal layer is subjected to contact exposure, using an original plate (photomask) of a predetermined pattern (consisting of the line parts 203b of the mesh part 203 and the frame part 201); the exposed metal layer is developed with water, subjected to film-hardening treatment, and baked. While continuously or intermittently transferring the belt-shaped laminate in the rolled-up state, a resist such as casein, PVA, or gelatin is applied to the metal layer surface of the laminate by such a method as dipping, curtain coating, or flow coating. Alternatively, a dry film resist may be used instead of coating a resist. The use of a dry film resist improves workability. It is referable to bake the resist at a temperature as low as possible in order to prevent the laminate from curling.

(Etching)

After masking the laminate with the resist, etching is conducted. In the case where etching is continuously conducted, it is preferable to use, as an etchant, a solution of ferric chloride or cupric chloride that is easy to recycle. Further, the etching step is basically the same as the process of producing a shadow mask for a cathode ray tube of color TV; in this process, belt-shaped continuous steel stock, especially a thin plate with a thickness of 20 to 80 μm, is etched. Namely, the existing facilities for producing a shadow mask can be used, and a series of the steps of from masking to etching can be continuously effected, so that considerably high efficiency can be attained. After etching, the laminate is washed with water, subjected to resist stripping using an alkaline solution, cleaned, and then dried.

(Mesh)

The mesh part 203 has a plurality of two-dimensionally arranged openings 203a that adjoin one another, and line parts 203b that border the openings 203a. The opening 203a may, in its plan view, be in any shape, for example, a triangle such as an equilateral triangle, a square such as a regular square, rectangular, rhombus or trapezoid, a polygon such as a hexagon, a circle, or an oval. The openings 203a of only one of, or two or more of the above types form the meshes. From the viewpoint of the opening rate and the invisibility of the meshes, it is preferable that the width of the line parts 203b be 25 μm or less, more preferably 20 μm or less. From the viewpoint of light transmittance, it is preferable that the distance between the line parts 203b (line pitch) be 100 μm or more, more preferably 200 μm or more. In order to avoid the occurrence of moiré fringes or the like, the bias angle between the line parts 203b and the borders of the electromagnetic wave shielding layer may be properly selected with consideration for the pixel and emission properties of a display.

(Blackening Treatment)

Preferably, a blackening treatment layer 37 is provided by blackening treatment at least on the transparent protective layer 50 side surface of the metal layer 35. Alternatively, blackening treatment layers 37 may be provided on both surfaces of the metal layer 35. To provide blackening treatment layers on both surfaces of the metal layer 35, the following method may be employed: the metal layer 35 in the form of a single layer is subjected to blackening treatment, thereby forming on the layer a blackening treatment layer; this metal layer 35 is laminated to the transparent substrate film 31 with the blackening treatment layer 37 facing to the transparent substrate film 31; and the bare surface of the metal layer 35 on the side opposite to the transparent substrate film 31 is then subjected to blackening treatment.

If the blackening treatment is conducted after photolithographically forming the mesh part 203, both the surface (the surfaces of the line parts 203b) and the side faces (the side faces of the line parts 203b) of the metal layer 35 are blackened, so that when extraneous light such as sunlight and light from electric lights is incident on a display, the line parts 203b for shielding electromagnetic waves prevent the display from reflecting the extraneous light. Consequently, an image on the display appears in an excellent state and can be viewed with high contrast.

The blackening treatment may be conducted by roughening (diffusion of incident light) and/or blackening (absorption of incident light) the surface of the metal layer, and, for this purpose, the deposition of a metal, an alloy, or a metallic oxide or sulfide, or any of the other various methods may be employed. Plating is preferred as a means for the blackening treatment, and by plating, there can be obtained a blackening treatment layer that is highly adhesive to the metal layer and that can blacken the surface of the metal layer 35 and the side faces (cross section) of the mesh part 203 simultaneously, uniformly, and easily. At least one metal selected from copper, cobalt, nickel, zinc, tin, and chromium, or a chemical compound of these metals may be used for plating. With other metals or compounds, it is impossible to fully conduct the blackening treatment, and the blackening treatment layers obtained are poor in adhesion to the metal layer.

In the case where copper foil is used as the metal layer 35, a preferable plating process is cathodic electrodeposition plating in which copper foil is subjected to cathodic electrolysis in an electrolyte such as sulfuric acid, copper sulfate, cobalt sulfate, or the like, thereby depositing cationic particles. The cationic particles deposited roughen the metal layer 35 to a higher degree, and, at the same time, blacken the metal layer. Although the cationic particles may be either copper particles or particles of an alloy of copper and any other metal, copper-cobalt alloy particles are preferred. The mean particle diameter of copper-cobalt alloy particles is preferably from 0.1 to 1 μm. By cathodic electrodeposition, it is possible to suitably deposit uniform particles with a mean particle diameter of 0.1 to 1 μm. If treated at high current density, the surface of copper foil becomes cathodic, generates reducing hydrogen, and is thus activated, so that there can be obtained significantly improved adhesion between the copper foil and the particles. When the mean particle diameter of copper-cobalt alloy particles is made greater than the above range, the thickness of the metal layer becomes smaller, and processability becomes worse, for example, the metallic foil is broken in the step of laminating to the substrate film. Moreover, the external appearance of the congregated particles becomes poor in denseness, and the non-uniformity of the external appearance and that of light absorption become noticeable. On the other hand, when the mean particle diameter is less than the above range, the metal layer is not sufficiently roughened, which leads to low image visibility. The blackening treatment using black chromium or nickel is also preferred because such a material is excellent in both electrical conductivity and blackness and its particles do not fall off.

The color tone was indicated by the color system “L*, a*, b*, and ΔE*” according to JIS-Z8729 as the optical properties useful in evaluating the visibility of the electromagnetic wave shielding layer 30. When the absolute values of “a*” and “b*” are smaller, the conductive material is more invisible, and higher contrast is obtained; as a result, higher image visibility can be obtained.

In this Specification, roughening and blackening are collectively referred to as blackening treatment. The reflection value Y of the blackening treatment layer is preferably 5 or less. The reflection value Y was measured by a spectrophotometer UV-3100PC (manufactured by Shimadzu Corp., Japan), at an angle of incidence of 5° (wavelength: 380-780 mm). From the viewpoint of image visibility, it is preferable that the blackening treatment layer has a light reflectance of 5% or less.

(Anticorrosive Layer)

An anticorrosive layer 37a may be provided on the metal layer 35 surface and/or the blackening treatment layer 37 surface, and it is preferable to provide the anticorrosive layer 37a at least on the surface of the blackening treatment layer 37. The anticorrosive layer 37a has the function of preventing the metal layer 35 and the blackening treatment layer 37 from corrosion, and also the function of, when the blackening treatment layer 37 contains particles, preventing falling or deformation of the particles. For the anticorrosive layer 37a, although conventional anticorrosive layers may be used, a layer of an oxide of nickel, zinc and/or copper, or a chromate treatment layer is suited. A conventional plating process may be used to form a layer of an oxide of nickel, zinc and/or copper, and the thickness of the deposit layer is approximately from 0.001 to 1 μm, preferably from 0.001 to 0.1 μm.

(Chromate Treatment)

Chromate treatment is that a chromate treatment liquid is applied to an object to be treated. For the application of a chromate treatment liquid, a roll, curtain, squeeze, electrostatic spray, or dip coating method may be employed, for example. After application, the chromate treatment liquid applied is not washed away with water but is dried as it is. An aqueous solution containing 3 g/l of CrO₂ is usually used as the chromate treatment liquid. Specific examples of the chromate treatment liquid include Alsurf 1000 (trademark of a chromate treatment agent, manufactured by Nippon Paint Co., Ltd., Japan) and PM-284 (trademark of a chromate treatment agent, manufactured by Nippon Parkerizing Co., Ltd., Japan). The chromate treatment can further enhance the effect of the blackening treatment.

(Smoothing Resin Layer)

FIG. 3 is a cross-sectional view of the mesh part of the electromagnetic wave shielding layer. A smoothing resin layer 39 is provided on the surface of the blackening treatment layer 37 in the laminate of the transparent substrate film 31/the metal layer 35/the blackening treatment layer 37, laminated by a photolithographic or plating process. When the mesh part 203 is formed as is shown in FIG. 3, although the frame part 201 and the line parts 203b of the mesh part have a thickness equal to the thickness of the metallic foil, the openings 203a, made by removing the metal layer 35, form cavities (concavities), and the mesh part thus has irregularities. In the case where an adhesive or pressure-sensitive adhesive is applied in the subsequent step, although the concavities are filled with this adhesive or pressure-sensitive adhesive, the adhesive or pressure-sensitive adhesive fills in not all the corners of the concavities and includes air bubbles, which leads to decrease in transparency and image visibility. It is therefore necessary to provide the step of deaeration that is effected under pressure or vacuum.

Further, when the front panel is attached, as it is, to a display after the formation of the mesh part, since the mesh part has bare irregularities, the front panel is easily harmed and is poor in working characteristics. Therefore, the smoothing resin layer 39 is provided in order to fill the concavities by spreading it to all the corners of the concavities in the mesh part 203, and also to protect the metal layer 35. A resin for the smoothing resin layer 39 is applied to the metal layer 35 to cover it. As shown in FIG. 3A, the surface of the metal layer 35 may be smoothed by filling the concavities in the openings with the smoothing resin layer 39, and forming the smoothing resin layer 39 also on the metal layer 35. Alternatively, the surface of the smoothing resin layer 39 may not be smooth, as shown in FIG. 3B, due to the irregularities of the metal layer. In brief, what is essential for the smoothing resin layer 39 is that it covers the openings 203a and the metal layer 35 and spreads to all the corners of the concavities in the mesh part 203, thereby lessening the irregularities of the metal layer.

Any resin layer may be used for the smoothing resin layer 39 as long as it is highly transparent and highly adhesive to the metal of the mesh part and also to an adhesive that is used in the subsequent step. Any resin can be used for the smoothing resin layer 39 as long as it is transparent, and conventional thermoplastic resins, thermosetting resins, reactive resins, and ionizing radiation curing resins, and mixtures of these resins may be used. In the case where a thermosetting resin is used for the smoothing resin layer 39, if a coloring agent that will be described later, especially a diimmonium compound, is incorporated, the coloring agent undergoes change in the course of hardening reaction with a hardening agent having a functional group such as isocyanate group and tends to lose its function. Further, in the case where an electron beam (EB) or ultraviolet light (UV) curing resin is used for the smoothing resin layer 39, the coloring agent can undergo color change or fading, or lose its function when EB or UV is applied. For this reason, thermoplastic resins are preferred.

Examples of thermoplastic resins useful herein include vinyl chloride resins such as vinyl chloride vinyl acetate copolymers, vinyl chloride vinyl alcohol acetate copolymers, and vinyl chloride acrylonitrile copolymers; acrylic resins such as polymethyl (meth)acrylate, polybutyl (meth)acrylate, and acrylic ester acrylonitrile copolymers; polyolefin resins such as cyclic polyolefins; styrene acrylonitrile resins; polyvinyl butyral; polyester resins; polycarbonate resins; urethane resins; amide resins; cellulose resins (cellulose acetate butyrate, cellulose diacetate, cellulose triacetate, cellulose propionate, nitrocellulose, ethyl cellulose, methyl cellulose, propyl cellulose, methyl ethyl cellulose, carboxymethyl cellulose, acetyl cellulose, etc.); and mixtures of these resins. In this Specification, modified cellulose resins are also included in the synthetic resins. Preferable thermoplastic resins are acrylic resins, acrylonitrile resins, urethane resins, and polyester resins. Thermoplastic resins are advantageous in that they satisfactorily dissolve and stably preserve dyes that serve as the coloring agents, and that the dyes dissolved in these resins can maintain their functions.

(Incorporation of Coloring Agents)

In the smoothing resin layer 39 is incorporated the following combination of coloring agents:

(1) a near infrared rays absorbing agent (NIR absorbing agent) and a coloring agent for color tone correction (Ne atom emission spectrum absorbing agent), (2) a near infrared rays absorbing agent (NIR absorbing agent), a coloring agent for color tone correction (Ne atom emission spectrum absorbing agent), and a coloring agent for color tone adjustment, (3) a near infrared rays absorbing agent (NIR absorbing agent), or (4) a coloring agent for color tone correction. In the case of (3), a coloring agent for color tone correction (Ne atom emission spectrum absorbing agent) may be incorporated in the third transparent adhesive layer 41 that is formed separately. In the case of (4), a near infrared rays absorbing agent may be incorporated in the third transparent adhesive layer 41 that is formed separately.

(Near Infrared Rays Absorbing Agent)

Any agent capable of absorbing near infrared rays to such a practical extent that its transmittances for near infrared rays with wavelengths of 800 to 1100 nm emitted from PDPs will be 20% or less, preferably 10% or less, can be used as the near infrared rays absorbing agent. Examples of the near infrared rays absorbing agent useful herein include near infrared rays absorbing dyes having a sharp absorption end at the boundary between the near infrared region and the visible light range and being highly transparent to light in the visible light region, such as polymethine dyes, cyanine compounds, phthalocyanine compounds, naphthalocyanine compounds, naphthoquinone compounds, anthraquinone compounds, dithiol compounds, immonium compounds, and diimmonium compounds.

(Coloring Agent for Color Tone Correction)

PDPs generate the inherent emission spectrum light (unwanted light) of insert gases (e.g., neon, etc.) characteristic of PDPs to decrease the color purity of images. It is therefore necessary to provide a layer containing “a coloring agent for color tone correction” that absorbs the emission spectrum light to correct the color tone of a displayed image. A coloring agent for color tone correction, showing the maximum absorption at a wavelength of 570 to 605 nm, is incorporated in the layer. Conventional dyes or pigments showing absorption at the desired wavelengths in the visible light range are used for the coloring agent for color tone correction. Useful herein are dyes or pigments of any type, including organic dyes such as anthraquinone, phthalocyanine, methine, azomethine, oxazine, azo, styryl, coumarin, porphyrin, dibenzofuranone, diketopyrrolopyrrole, rhodamine, xanthene, and pyrromethene dyes.

(Coloring Agent for Color Tone Adjustment)

A coloring agent for color tone adjustment is used for improving transmission image contrast and for making color adjustment. Such a coloring agent absorbs visible light and is useful in varying the color tone of an image to adjust it to a favorite one. Examples of coloring agents useful herein include organic or inorganic pigments such as monoazo pigments, quinacridone, thioindigo bordeaux, perylene maroon, aniline black, blood red, chromium oxide, cobalt blue, ultramarine, and carbon black; and dyes such as indigoid dyes, carbonium dyes, quinoline dyes, nitroso dyes, naphthoquinone dyes, and perinone dyes. Preferable coloring agents (dyes or pigments) are rhodamine, porphyrin, cyanine, squarilium, azomethine, xanthene, oxonol, and azo compounds that show the maximum absorption at a wavelength of 560 to 620 nm; cyanine dyes, merocyanine dyes, oxonol dyes, methine dyes such as arylidene dyes and styryl dyes, anthraquinone dyes, quinone dyes, diphenylmethane dyes, triphenylmethane dyes, xanthene dyes, azo compounds, and azomethine compounds that show the maximum absorption at a wavelength of 380 to 440 nm; and cyanine, squarilium, azomethine, xanthene, oxonol, azo, anthraquinone, triphenylmethane, xanthene, copper phthalocyanine, phenothiazine, and phenoxazine compounds that show the maximum absorption at a wavelength of 640 to 780 nm. These compounds may be used either singly or as a mixture.

The type and amounts of the coloring agents to be used may be properly selected depending on the absorption wavelengths and absorption coefficients of the coloring agents, the desired color tone, the transmittance required for the front panel for display, and so on. For example, the near infrared rays absorbing agent is incorporated in the layer in an amount of approximately 0.1 to 15% by weight of the layer, and the coloring agent for color tone correction or the coloring agent for color tone adjustment is incorporated in the layer in an amount of approximately 0.00001 to 2% by weight of the layer. In order to protect these coloring agents from ultraviolet light, a benzophenone or benzotriazole ultraviolet light absorber may be added to the layer. The amount of the ultraviolet light absorber to be added is from 0.1 to 10% by weight of the layer.

(Formation of Smoothing Resin Layer)

To form the smoothing resin layer 39, a resin is applied so that the concavities in the openings 203a in the mesh part 203 are filled in with the resin. At this time, if the resin does not spread to all the corners of the concavities, the resin layer formed contains air bubbles and has decreased transparency. Therefore, by dissolving in a solvent or the like, the resin is made into a composition (ink) having a low viscosity, and this composition is applied and dried to form a layer. It is preferable from the viewpoint of uniform dispersion that the composition (ink) be prepared in the following manner; the above-described resin is dispersed or dissolved in a solvent such as methyl ethyl ketone, ethyl acetate and/or toluene; separately, the coloring agents are dispersed or dissolved in a similar solvent; and these dispersions or solutions are blended. The composition may be applied by a conventional printing or coating method such as screen printing, gravure printing, gravure offset printing, roll coating, reverse roll coating, spray coating, die coating, gravure coating, gravure reverse coating, or comma coating. If the composition does not spread to all the corners of the concavities, the composition layer applied contains air bubbles and has decreased transparency. Therefore, the composition is diluted in a solvent or the like, and the dilute composition with a low viscosity is applied and then dried; or the composition is applied while conducting deaeration.

(Pattern-Wise Formation of Smoothing Resin Layer)

In the case where the electromagnetic wave shielding layer 30 includes the mesh part 203 and the frame part 201 surrounding the mesh part 203, it is preferable that the smoothing resin layer 39 be applied pattern-wise, as shown in FIG. 2, and intermittent die coating is preferred as a method of pattern-wise application. The pattern is that the smoothing resin layer applied covers the mesh part 203 but does not cover at least a part of the frame part 201 so that the metal layer 35, a part of the frame part 201, remains bare to serve as a ground. The bare part may be the whole frame part 201, or one of, or two or more of the upper, lower, left-hand, and right-hand sides of the periphery of the frame part 201, or a part of any one of these sides of the same.

Since the frame part 201 surface on the side opposite to the transparent substrate 11 is bare, it is easy to connect the frame part 201 to the body of equipment, or the like for grounding. Further, the smoothing resin layer 39 is applied pattern-wise only to the necessary part, so that it is possible to reduce material costs. Furthermore, in the prior art, since a terminal area for grounding is not bare, a processing operation for making a bare terminal area has so far been separately conducted; however, in the present invention, such a processing operation is unnecessary because the smoothing resin layer is applied pattern-wise so that a part of the frame part remains bare.

In the present invention, the near infrared rays absorbing agent (NIR absorbing agent) and the coloring agent for color tone correction (Ne absorbing agent) may be separately incorporated in the smoothing resin layer 39 and the third transparent adhesive layer 41, respectively. In this case, it is easy to control only the coloring agent for color tone correction that requires adjustment of transmittance. Further, in the case where the coloring agent for color tone adjustment is incorporated in the third transparent adhesive layer 41 in addition to the coloring agent for color tone correction (Ne absorbing agent), the step of color tone adjustment can be effected at a point close to the end of the whole process. In this case, since it is possible to produce semi-finished products in a lump according to the common specifications in the steps prior to the step of color tone adjustment, final products can be produced at low cost, and moreover, the color tone of an image can be easily adjusted according to customer's preference in the step of color tone adjustment.

(Pre-Processing of Transparent Protective Layer)

Next, the transparent protective layer 50 is prepared. Although the transparent protective layer 50 may be composed only of a transparent protective substrate film 51, an anti-reflection layer 53 and/or an anti-glaring layer 55 is usually further provided on the surface of the transparent protective substrate film 51. Those materials similar to the materials for the transparent substrate film 31 may be used for the transparent protective substrate film 51.

(Anti-Reflection Layer)

A conventional anti-reflection film can be used as the anti-reflection layer 53. The anti-reflection layer may be any of conventional ones in which a film is, in the following manner, formed on the transparent substrate film 51 directly or through a hard coat layer.

(1) A manner that an anti-reflection layer is obtained by forming an extremely thin film with a thickness of approximately 0.1 μm, made of a low refractive index layer having a refractive index lower than that of the transparent protective substrate film or of the hard coat layer, comprising MgF₂ or the like.

(2) A manner that an anti-reflection layer is obtained by forming a low refractive index layer on a high refractive index layer having a refractive index higher than that of the transparent protective film or of the hard coat layer, comprising titanium oxide, zirconium oxide, or the like. For example, in the part of the anti-reflection layer that comes in contact with the hard coat layer, a layer of ultrafine particles of a metallic oxide, having a high refractive index, may be unevenly distributed.

(3) A manner that an anti-reflection layer is obtained by repeatedly laminating the above-described low refractive index layer and high refractive index layer.

(4) A manner that an anti-reflection layer is obtained by providing a medium refractive index layer, a high refractive index layer, and a low refractive index layer.

An anti-reflection layer capable of more effectively preventing reflection is a laminate obtained by successively laminating, to the transparent substrate film, a medium refractive index layer, a high refractive index layer, and a low refractive index layer in this order through the hard coat layer.

The hard coat layer is a layer having a pencil hardness of H or more as determined by pencil hardness tests according to JIS K5400, and can be obtained by curing a polyfunctional acrylate such as polyester acrylate, urethane acrylate, or epoxy acrylate in heat or ionizing radiation. More preferably, the anti-reflection layer composed of a low refractive index layer, a medium refractive index layer, and a high refractive index layer that are SiO_{X} layers fulfill the inequality 2.20>the refractive index of the high refractive index layer>the refractive index of the medium refractive index layer>the refractive index of the low refractive index layer>1.40, and also meet the following conditions: the low refractive index layer has a thickness of 80 to 110 nm, the high refractive index layer has a thickness of 30 to 110 nm, and the medium refractive index layer has a thickness of 50 to 100 nm and an optical film thickness D (D=n·d, where n is the refractive index of the medium refractive index layer, and d is the thickness of the medium refractive index layer).

(Anti-Glaring Layer)

The anti-glaring layer 55 is for preventing the glaring and flickering of an image displayed. For the anti-glaring layer 55, conventional ones may be used, and preferable ones are layers containing inorganic fillers such as silica, or layers having surfaces with fine irregularities that scatter extraneous light. A layer containing an inorganic filler is formed in the following manner: in a curing resin, for example, an acrylic resin such as a polyacrylate copolymer consisting of ethyl acrylate, butyl acrylate, 2-ethylhexyl acrylate, t-butyl acrylate or the like, a diene resin, a polyester resin, or a silicone resin, silica particles with a mean particle diameter of usually 30 μm or less, preferably about 2 to 15 μm, are dispersed in an amount of approximately 0.1 to 10 parts by weight for 100 parts by weight of the resin; this dispersion is applied by gravure, reverse roll or die coating so that the dry film has a thickness of approximately 5 to 30 μm, followed by drying; and heat, ultraviolet light, or electron beams are applied, as needed, to harden the film. For the layer having a surface with fine irregularities, there may be used conventional ones such as a layer formed by using the resin and the coating method that are used in the formation of the inorganic-filler containing layer and embossing irregularities on the layer; a layer obtained by applying a resin to a plate cylinder having irregularities, curing the applied resin in UV, and peeling the resin layer off from the plate cylinder, thereby transferring the irregularities to the surface of the resin layer; and a layer obtained by applying a resin to a shaping film with irregularities, curing the applied resin in UV, and peeling the resin layer off from the shaping film, thereby transferring the irregularities to the surface of the resin layer.

(Anti-Staining Layer)

An anti-staining layer 55a may be provided on the anti-reflection layer 53 and/or the anti-glaring layer 55. The anti-staining layer 55a is usually a water- and oil-repellent coat, and siloxane compounds, fluorinated alkylsilyl compounds, and the like may be used for this layer. Fluoroplastics or silicone resins that are used as water-repellent coatings are suitably used. For example, in the case where the low refractive index layer in the anti-reflection layer is made from SiO₂, it is preferable to use a fluorosilicate water-repellent coating.

(Production of Front Panel for Plasma Display)

Thus, there are prepared the electromagnetic wave shielding layer 30, the transparent protective layer 50, the transparent substrate 11, the first transparent adhesive layer 21, and the third transparent adhesive layer 41. Thereafter, the electromagnetic wave shielding layer 30 is laminated to the transparent substrate 11 with the first transparent adhesive layer 21, and the transparent protective layer 50 is then laminated to the electromagnetic wave shielding layer 30 with the third transparent adhesive layer 41, thereby obtaining a front panel 103 for plasma display.

In this case, the electromagnetic wave shielding layer 30 is laminated to the transparent substrate 11 with the first transparent adhesive layer 21, with the transparent substrate film 31 of the former facing to one surface of the latter. For this lamination is used a conventional lamination process such as a process (1) in which the first transparent adhesive layer 21, which is a pressure-sensitive adhesive layer formed on release paper, is stuck to either the transparent substrate 11 or the electromagnetic wave shielding layer 30, the release paper is peeled off, and the other member is attached to this adhesive layer with pressure, or a process (2) in which an ink composition prepared by dissolving or dispersing, in a solvent, an adhesive for the first transparent adhesive layer 21 is applied to either the transparent substrate 11 or the electromagnetic wave shielding layer 30 and is dried, the other member is then superposed on the ink composition layer, pressure is applied to this laminate with a roll, a plate, or the like, and heat or ionizing radiation is, as needed, applied to cure the ink composition layer.

The electromagnetic wave shielding layer 30 is laminated to the transparent protective layer 50 with the third transparent adhesive layer 41, with the metal layer 35 of the former facing to the transparent substrate film 51 of the latter. For this lamination, it is possible to use the same lamination process as the above-described one used for laminating the transparent substrate 11 and the electromagnetic wave shielding layer 30 with the first transparent adhesive layer 21.

(Incorporation of Coloring Agents)

The manner in which at least one of the coloring agents, that is, the near infrared rays absorbing agent (NIR absorbing agent), the coloring agent for color tone correction (e.g., a Ne absorbing agent), and the coloring agent for color tone adjustment, is incorporated in the third transparent adhesive layer 41 may be as follows: an ink composition prepared by dissolving or dispersing, in a solvent, an adhesive and a coloring agent for the third transparent adhesive layer 41 is applied to either the electromagnetic wave shielding layer 30 or the transparent protective layer 50 and is then dried; the other member is superposed on the ink composition layer; and pressure is applied to this laminate with a roll, a plate, or the like. From the viewpoint of uniform dispersion of the coloring agent, it is preferable to prepare the ink composition in the following manner: the coloring agent is dissolved or dispersed in a solvent in advance; the adhesive is also separately dissolved or dispersed in a solvent; and these two solutions or dispersions are blended or re-dispersed. Any method can be used for blending or dispersing the solutions or dispersions, and a conventional dispersion mixer such as a disper, mixer, tumbler, blender, homogenizer, or ball mill may be used.

According to the present invention, the near infrared rays absorbing agent (NIR absorbing agent), the coloring agent for color tone correction (Ne absorbing agent), and the coloring agent for color tone adjustment are incorporated in the third transparent adhesive layer 41. Alternatively, according to the present invention, the coloring agent for color tone correction (Ne absorbing agent) and the coloring agent for color tone adjustment may be incorporated in the third transparent adhesive layer 41. This step of incorporation is effected at a point close to the end of the whole process, and the coloring agent for color tone adjustment that has been selected according to customer's preference is incorporated in semi-finished products that have been produced in a lump according to the common specifications in the steps prior to the step of incorporation. It is therefore possible to adjust the color tone of an image displayed, and, at the same time, reduce costs.

(Assembly of Plasma Display)

Subsequently, the front panel 103 for plasma display is mounted on the front of a PDP 101, thereby obtaining a plasma display 100. At this time, the front panel 103 for plasma display is set so that the transparent substrate 11 of the front panel 103 faces to the PDP (plasma display element) 101. An air layer may be present between the front panel 103 for plasma display and the PDP 101, or these two members may be directly attached to each other with an adhesive or the like.

Since a part of the frame part of the metal layer 35 on the observation side surface of the front panel 103 for plasma display is bare, it is easy to ground the front panel 103 by connecting the bare part to the body of the plasma display 100 by a conventional conductive tape or the like. In a conventional front panel, the metal layer is not bare, so that there has been required the step of making the metal layer bare. According to the present invention, the plasma display 100 is viewed from the transparent protective layer 50 side. According to the present invention, the above-mentioned various functions and effects thereof are obtained.

### EXAMPLES

The present invention will now be explained more specifically by way of Examples and Comparative Examples. However, the present invention is not limited by these Examples.

### Example 1

(Preparation of Electromagnetic Wave Shielding Layer)

A biaxially oriented PET film A4300 (trademark, polyethylene terephthalate manufactured by Toyobo Co., Ltd., Japan) with a thickness of 100 μm, serving as the transparent substrate film, and electrolytic copper foil with a thickness of 10 μm, serving as the metal layer, were laminated with the second transparent adhesive layer made from a two-part curing urethane adhesive, and this was aged at 50° C. for 3 days, thereby obtaining a laminate. For the adhesive, polyester urethane polyol was used as the main agent, and xylene diisocyanate was used as the curing agent. The adhesive was applied in such an amount that the dry adhesive layer would have a thickness of 4 μm. A mesh part was photolithographically made in the copper foil in this laminate. Using the existing production line for shadow masks for color TV, the laminate in the form of a belt-shaped (rolled-up) continuous web was subjected to a series of the steps of from masking to etching. Firstly, a casein resist was applied to the entire surface of the copper layer in the laminate by flow coating. This laminate was intermittently transferred to the next station, where contact exposure was conducted by the use of an original plate of a negative pattern consisting of a mesh part having square openings with a line width of 22 μm, a line distance (pitch) of 300 μm, and a bias angle of 49 degrees, and a frame part with a width of 15 mm, surrounding the mesh part. The exposed laminate was then transferred from one station to another for development with water, for film-hardening treatment, and for baking by heating. Thereafter, the baked laminate was further transferred to the next station, where etching was conducted by spraying, as an etchant, an aqueous ferric chloride solution over the laminate, thereby making openings. This laminate was transferred from one station to another for washing with water, for resist stripping, for cleaning, and for drying at 60° C., thereby forming a copper mesh part. The copper mesh part was then subjected to blackening treatment. A blackening treatment layer was formed on the surfaces and side faces of the line parts of the mesh part by subjecting the mesh part to electrolytic plating using, as a blackening treatment plating bath, a black nickel plating bath.

Subsequently, a smoothing resin layer 39 was formed. A composition liquid for forming the smoothing resin layer was prepared by blending, with an acrylic resin, the below-described coloring agent dispersed or dissolved in methyl ethyl ketone, and adjusting the viscosity of the blend to 40 seconds as measured with a zane cup No. 3 (manufactured by Rigo Kabushiki Kaisha, Japan). A diimmonium colorant CIR1085 (trademark, manufactured by Japan Carlit, Co., Ltd., Japan), a phthalocyanine dye IR12 (trademark, manufactured by Nippon Shokubai Co., Ltd., Japan), and a phthalocyanine dye IR14 (trademark, manufactured by Nippon Shokubai Co., Ltd., Japan) were used as the near infrared rays absorbing agents (NIR absorbing agents). TAP-2 (trademark, manufactured by Yamada Chemical Co., Ltd., Japan) was used as the coloring agent for color tone correction (Ne absorbing agent). The above composition liquid for forming the smoothing resin layer was applied pattern-wise only to the mesh part by intermittent die coating and was dried, thereby obtaining an electromagnetic wave shielding layer.

(Preparation of Transparent Protective Layer)

An anti-reflection film TAC-AR1 (trademark, manufactured by Dai Nippon Printing Co., Ltd., Japan) produced by laminating a hard coat layer, a low refractive index layer, and an anti-staining layer to an 80-μm thick triacetyl cellulose (TAC) film was used as the transparent protective layer. An acrylic resin-made substrate with a thickness of 5 mm was used as the transparent substrate, and a pressure-sensitive adhesive HJ-9150W (trademark, manufactured by NITTO DENKO CORPORATION, Japan) was used for the first transparent adhesive layer. The electromagnetic wave shielding layer was laminated to the transparent substrate through the first transparent adhesive layer, with the transparent substrate film of the electromagnetic wave shielding layer facing to the transparent substrate. A pressure-sensitive adhesive HJ-9150W (trademark, manufactured by NITTO DENKO CORPORATION, Japan) was used for the third transparent adhesive layer. The anti-reflection film TAC-AR1 (trademark, manufactured by Dai Nippon Printing Co., Ltd., Japan) was laminated to the third transparent adhesive layer, with the TAC film of the anti-reflection film facing to the electromagnetic wave shielding layer, thereby obtaining a front panel for plasma display of Example 1.

### Example 2

A front panel for plasma display was obtained in the same manner as in Example 1, except that PS Violet RC (trademark, manufactured by Mitsui Toatsu Dyes, Ltd., Japan) was further added, as the coloring agent for color tone adjustment, to the composition liquid for forming the smoothing resin layer in an amount (dry basis) of 0.109 g/m².

### Example 3

A front panel for plasma display was obtained in the same manner as in Example 1, except that the four coloring agents used in Example 1 were incorporated in the third transparent adhesive layer and that no coloring agent was incorporated in the smoothing resin layer.

### Example 4

A front panel for plasma display was obtained in the same manner as in Example 2, except that PS Violet RC (trademark, manufactured by Mitsui Toatsu Dyes, Ltd., Japan) was further added, as the coloring agent for color tone adjustment, to the third transparent adhesive layer in an amount (dry basis) of 0.109 g/m².

### Example 5

A front panel for plasma display was obtained in the same manner as in Example 1, except that the near infrared rays absorbing agents (NIR absorbing agents) were incorporated in the smoothing resin layer and that the coloring agent for color tone correction (Ne absorbing agent) was incorporated in the third transparent adhesive layer.

### Example 6

A front panel for plasma display was obtained in the same manner as in Example 5, except that a 3-mm thick glass plate was used as the transparent substrate.

### Example 7

A front panel for plasma display was obtained in the same manner as in Example 5, except that a coloring agent for color tone adjustment was further added to the third transparent adhesive layer.

### Example 8

A front panel for plasma display was obtained in the same manner as in Example 7, except that a 3-mm thick reinforced glass plate was used as the transparent substrate.

### Example 9

The front panel for plasma display of Example 1 was mounted on the front of a PDP “WOOO” (trademark, manufactured by Hitachi Ltd., Japan) through a 5-mm thick air layer, thereby obtaining a plasma display.

### Example 10

The front panel for plasma display of Example 7 was attached to the front of a PDP “WOOO” (trademark, manufactured by Hitachi Ltd., Japan) with a pressure-sensitive adhesive HJ-9150W (trademark, NITTO DENKO CORPORATION, Japan), thereby obtaining a plasma display.

(Evaluation)

The above front panels were evaluated in terms of the color tone of an image, the color fastness of the coloring agents, and image visibility. The color tone of an image was evaluated by visually observing the color tone of a TV test pattern displayed, and the front panel that showed no abnormality was indicated by “◯”. The color fastness of the coloring agents was evaluated by visually observing the color of the front panel before and after resistance-to-moist-heat tests (preserved in an atmosphere of 60° C. and 95% RH for 1000 hours). The front panel that underwent no significant change in color was indicated by “◯”, and the front panel that underwent almost no change in color was indicated by “⊚”. Image visibility was evaluated by visually observing the color tone of a black-and-white image displayed, and the front panel that caused neither glaring nor remarkable mirroring of extraneous light was indicated “◯”. The results are shown in Tables 1 and 2.

TABLE 1

| No. | Item | Example 1 | Example 2 | Example 3 | Example 4 |
|---|---|---|---|---|---|
| 11 | substrate | acrylic | acrylic | acrylic | acrylic |
| 21 | adhesive | pressure-sensitive | pressure-sensitive | pressure-sensitive | pressure-sensitive |
| | | adhesive | adhesive | adhesive | adhesive |
| 31 | substrate | PET 100μ | PET 100μ | PET 100μ | PET 100μ |
| | film | | | | |
| 33 | presence of | present | present | present | present |
| | adhesive C-2 | | | | |
| 35 | mesh-making | photolithographic | photolithographic | photolithographic | photolithographic |
| | process | | | | |
| 39 | resin | acrylic | acrylic | acrylic | acrylic |
| | NIR | present | present | — | — |
| | absorbing | | | | |
| | agent | | | | |
| | Ne light | present | present | — | — |
| | absorbing | | | | |
| | agent | | | | |
| | Coloring | — | present | — | — |
| | agent for | | | | |
| | color tone | | | | |
| | adjustment | | | | |
| 41 | adhesive | pressure-adhesive | pressure-adhesive | pressure-adhesive | pressure-adhesive |
| | | adhesive | adhesive | adhesive | adhesive |
| | NIR | — | — | present | present |
| | absorbing | | | | |
| | agent | | | | |
| | NE light | — | — | present | present |
| | absorbing | | | | |
| | agent | | | | |
| | Coloring | — | — | — | present |
| | agent for | | | | |
| | color tone | | | | |
| | adjustment | | | | |
| 50 | Protective | present | present | present | present |
| | layer | | | | |
| Evaluation | fastness of | ∘ | ∘ | ∘ | ∘ |
| | coloring | | | | |
| | agents | | | | |

TABLE 2

| No. | Item | Example 5 | Example 6 | Example 7 | Example 8 |
|---|---|---|---|---|---|
| 11 | substrate | acrylic | acrylic | acrylic | glass |
| 21 | adhesive | pressure-sensitive | pressure-sensitive | pressure-sensitive | pressure-sensitive |
| | | adhesive | adhesive | adhesive | adhesive |
| 31 | substrate | PET 100μ | PET 100μ | PET 100μ | PET 100μ |
| | film | | | | |
| 33 | presence of | present | absent | present | present |
| | adhesive C-2 | | | | |
| 35 | mesh-making | photolithographic | plating | photolithographic | plating |
| | process | | | | |
| 39 | resin | acrylic | acrylic | acrylic | acrylic |
| | NIR | present | present | present | present |
| | absorbing | | | | |
| | agent | | | | |
| | Ne light | — | — | — | — |
| | absorbing | | | | |
| | agent | | | | |
| | Coloring | — | — | — | — |
| | agent for | | | | |
| | color tone | | | | |
| | adjustment | | | | |
| 41 | adhesive | pressure-sensitive | pressure-sensitive | pressure-sensitive | pressure-sensitive |
| | | adhesive | adhesive | adhesive | adhesive |
| | NIR | — | — | — | — |
| | absorbing | | | | |
| | light | | | | |
| | NE light | present | present | present | present |
| | absorbing | | | | |
| | agent | | | | |
| | Coloring | — | — | present | present |
| | agent for | | | | |
| | color tone | | | | |
| | adjustment | | | | |
| 50 | Protective | present | present | present | present |
| | layer | | | | |
| Evaluation | fastness of | ∘ | ∘ | ∘ | ∘ |
| | coloring | | | | |
| | agents | | | | |

The results of evaluation carried out in terms of the color fastness of the coloring agents were as follows: the front panels of Examples 3 and 4 were “◯”, and those of Examples 1, 2, 5, 6, 7 and 8 were “⊚”. Although not shown in the tables, the results of evaluation of the plasma displays of Examples 9 and 10 carried out in terms of the color tone of an image and image visibility were both “◯”.

1. A front panel for plasma display, comprising:
a transparent substrate,
a first transparent adhesive layer provided on the transparent substrate,
an electromagnetic wave shielding layer provided on the first transparent adhesive layer,
a third transparent adhesive layer provided on the electromagnetic wave shielding layer, and
a transparent protective layer provided on the third transparent adhesive layer,
the electromagnetic wave shielding layer comprising a transparent substrate film, a metal layer including a mesh part having a plurality of openings that adjoin one another, formed on the transparent substrate film, and a smoothing resin layer made from a transparent synthetic resin, filling at least part of the spaces in the openings in the metal layer,
the smoothing resin layer and/or the third transparent adhesive layer containing a near infrared rays absorbing agent and/or a coloring agent for color tone correction.

2. The front panel for plasma display according to claim 1, wherein
the smoothing resin layer and/or the third transparent adhesive layer contains both a near infrared rays absorbing agent and a coloring agent for color tone correction.

3. The front panel for plasma display according to claim 2, wherein
the smoothing resin layer and/or the third transparent adhesive layer further contains a coloring agent for color tone adjustment for adjusting the color tone of a displayed image to the desired one.

4. The front panel for plasma display according to claim 1, wherein
the smoothing resin layer contains a near infrared rays absorbing agent, and the third transparent adhesive layer contains a coloring agent for color tone correction.

5. The front panel for plasma display according to claim 4, wherein the third transparent adhesive layer further contains a coloring agent for color tone adjustment.

6. The front panel for plasma display according to claim 1, wherein
the metal layer further includes a frame part that surrounds the mesh part, and a part of the frame part is covered neither with the smoothing resin layer, nor with the third transparent adhesive layer, nor with the transparent protective layer and is thus bare.

7. The front panel for plasma display according to claim 1, wherein
the electromagnetic wave shielding layer comprises a second transparent adhesive layer between the transparent substrate film and the metal layer.

8. The front panel for plasma display according to claim 1, wherein
the transparent protective layer comprises a transparent protective substrate film and an anti-reflection layer and/or an anti-glaring layer provided on the transparent protective substrate film.

9. The front panel for plasma display according to claim 1, wherein
a blackening treatment layer is provided on the transparent protective layer side surface of the metal layer.

10. A plasma display comprising:
a front panel for plasma display, and
a plasma display element that faces to the front panel for plasma display,
the front panel for plasma display comprising:
a transparent substrate,
a first transparent adhesive layer provided on the transparent substrate,
an electromagnetic wave shielding layer provided on the first transparent adhesive layer,
a third transparent adhesive layer provided on the electromagnetic wave shielding layer, and
a transparent protective layer provided on the third transparent adhesive layer,
the electromagnetic wave shielding layer comprising a transparent substrate film, a metal layer including a mesh part having a plurality of openings that adjoin one another, formed on the transparent substrate film, and a smoothing resin layer made from a transparent synthetic resin, filling at least part of the spaces in the openings in the metal layer,
the smoothing resin layer and/or the third transparent adhesive layer containing a near infrared rays absorbing agent and/or a coloring agent for color tone correction,
the transparent substrate of the front panel for plasma display facing to the plasma display element, an image displayed being observed from the transparent protective layer side.

11. The plasma display according to claim 10, wherein
the smoothing resin layer and/or the third transparent adhesive layer contains both a near infrared rays absorbing agent and a coloring agent for color tone correction.

12. The plasma display according to claim 11, wherein
the smoothing resin layer and/or the third transparent adhesive layer further contains a coloring agent for color tone adjustment for adjusting the color tone of a displayed image to the desired one.

13. The plasma display according to claim 10, wherein
the smoothing resin layer contains a near infrared rays absorbing agent, and the third transparent adhesive layer contains a coloring agent for color tone correction.

14. The plasma display according to claim 13, wherein
the third transparent adhesive layer further contains a coloring agent for color tone adjustment.

15. The plasma display according to claim 10, wherein
the metal layer further includes a frame part that surrounds the mesh part, and a part of the frame part is covered neither with the smoothing resin layer, nor with the third transparent adhesive layer, nor with the transparent protective layer and is thus bare.

16. The plasma display according to claim 10, wherein
the electromagnetic wave shielding layer comprises a second transparent adhesive layer between the transparent substrate film and the metal layer.

17. The plasma display according to claim 10, wherein
the transparent protective layer comprises a transparent protective substrate film and an anti-reflection layer and/or an anti-glaring layer provided on the transparent protective substrate film.

18. The plasma display according to claim 10, wherein
a blackening treatment layer is provided on the transparent protective layer side surface of the metal layer.
